(19) United States
(12) Patent Application Publication
(10) Pub. No.: US 2012/0065930 A1
(43) Pub. Date: Mar. 15, 2012

(54) VICINITY SENSOR SYSTEM AND RELATED SYSTEMS AND METHODS

(75) Inventors: David R. Allee, Phoenix, AZ (US); Bruce Gnade, Lewisville, TX (US); Eric Forsythe, Rockville, MD (US)

(73) Assignees: Board of Regents, The University of Texas System, Austin, TX (US); Arizona Board of Regents, a Body Corporation of the State of Arizona Acting for and on Behalf of A, Scottsdale, AZ (US)

(21) Appl. No.: 13/298,485

(22) Filed: Nov. 17, 2011

Related U.S. Application Data
(63) Continuation of application No. PCT/US10/35669, filed on May 20, 2010.
(60) Provisional application No. 61/180,584, filed on May 22, 2009.
(60) Provisional application No. 61/260,086, filed on Nov. 11, 2009.

(51) Int. Cl. G06F 15/00; H04B 1/02

(52) U.S. Cl. 702/150; 455/91

(57) ABSTRACT

Embodiments of vicinity sensor systems are described herein. Other embodiments and related methods are also disclosed herein.

### CLAIM OF PRIORITY

This application is a continuation of PCT Application No. PCT/US2010/035669, filed May 20, 2010, which claims the benefit of (a) U.S. Provisional Patent Application No. 61/180,584, filed May 22, 2009, and (b) U.S. Provisional Patent Application No. 61/260,086, filed Nov. 11, 2009. PCT Application No. PCT/US2010/035669, U.S. Provisional Patent Application No. 61/180,584, and U.S. Provisional Patent Application No. 61/260,086 are incorporated herein by reference.

### STATEMENT REGARDING FEDERALLY SPONSORED RESEARCH OR DEVELOPMENT

At least part of the disclosure herein was funded with government support under grant number W911NF-04-2-0005, awarded by the Army Research Laboratory. The United States Government may have certain rights in this invention.

### FIELD OF THE INVENTION

This invention relates generally to sensor systems, and relates more particularly to vicinity sensor systems and related methods.

### BACKGROUND

In many situations, the ability to remotely monitor specific locations can be beneficial to gather information discretely and thereby formulate a response based on the gathered information. For example, a sensor installed to monitor an alley in an urban environment can be used to gather information about, for example, traffic flow, presence of individuals or vehicles, and/or illegal or dangerous activities, thereby eliminating the need to have individuals present at the desired location to gather relevant information.

Accordingly, a need exists for ground sensors and/or monitors forming a system for remote monitoring of desired locations, where the sensors and/or monitors, and/or any signals transmitted therefrom, are inconspicuous enough to avoid detection by bystanders, and where the sensors and/or monitors can be left unattended for indefinite periods of time once located at the vicinity of the location desired to be monitored.

### BRIEF DESCRIPTION OF THE DRAWINGS

To facilitate further description of examples and embodiments herein, the following drawings are provided in which:

FIG. 1 illustrates a block diagram of a monitor apparatus for a vicinity sensor system.

FIG. 2 illustrates a diagram of the monitor of FIG. 1 coupled to a placard.

FIG. 3 illustrates a diagram of the vicinity sensor system of FIG. 1 as implemented in an urban environment.

FIG. 4 illustrates a flowchart of a method for providing a vicinity sensor system in accordance with the present disclosure.

FIG. 5 illustrates a flowchart for a method of operating a vicinity sensor system in accordance with the present disclosure.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types. The absence of the word “removably,” “removable,” and the like near the word “coupled,” and the like does not mean that the coupling, etc. in question is or is not removable.

### DETAILED DESCRIPTION

In one embodiment, a system can be configured for remote monitoring of vicinities of apparatuses or monitors located at different structures. In one example of such an embodiment, the system can include a first apparatus having a first substrate and a first transmitter supported by the first substrate, where the first substrate can be at least one of a flexible substrate or a plastic substrate. The first transmitter can be configured to transmit one or more first signals imperceptible to an unaided human. In addition, when coupled to a surface, at least a portion of the first apparatus can be substantially imperceptible to an unaided human eye. There can also be embodiments where the first apparatus further includes a first sensor to scan a vicinity of the first apparatus such that the one or more first signals can include information related to the scan by the first sensor.

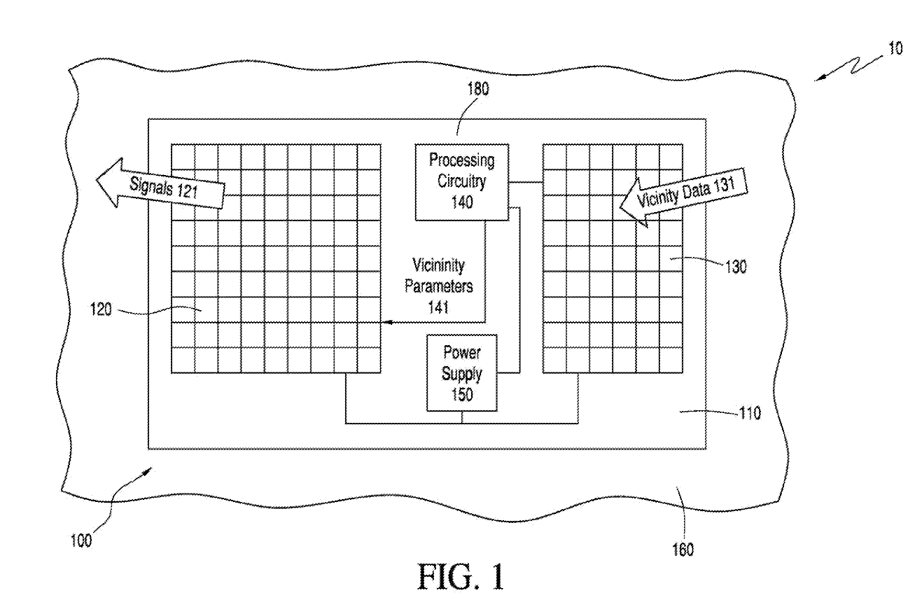

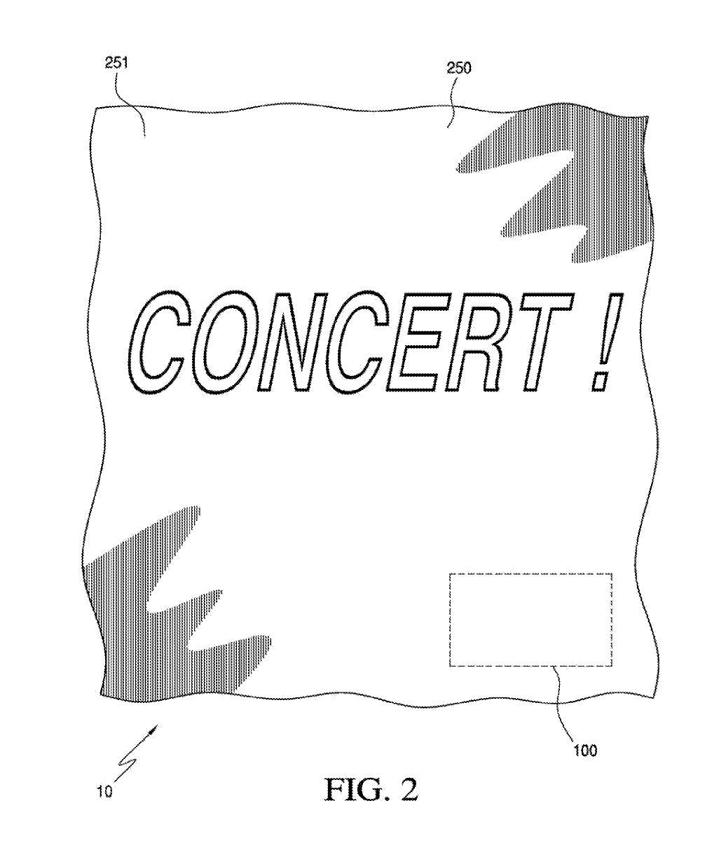

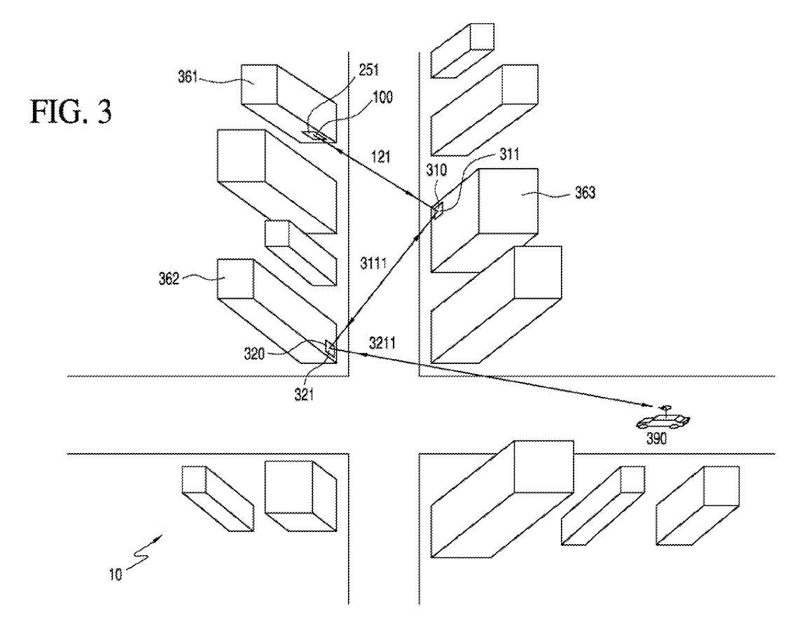

Turning to the drawings, FIG. 1 illustrates a diagram of monitoring apparatus 100 of sensor system 10. For simplicity, monitoring apparatuses such as monitoring apparatus 100 may be referred to simply as monitors in the present specification. FIG. 2 illustrates monitor 100 coupled to placard 251 for deployment as part of sensor system 10. FIG. 3 illustrates an implementation of sensor system 10 in an urban environment, where monitor 100 is deployed with placard 251 at structure 361. Sensor system 10 and its components, including monitor 100, are merely exemplary and not limited to the embodiments presented herein. In addition, sensor system 10 can be employed in many different embodiments or examples not specifically depicted or described herein.

In some applications, monitor 100 can be used as an unattended ground sensor to monitor a vicinity of monitor 100 when located in, for example, an urban environment as part of sensor system 10. There can be examples, as illustrated in FIG. 3, where vicinity sensor system 10 can further comprise other monitors, such as monitors 311 and 321, similar to monitor 100. In such examples, the different monitors of sensor system 10 can be used to transmit and/or forward information about each other's respective vicinities.

In the present example of FIG. 1, monitor 100 comprises substrate 110 and transmitter 120 over substrate 110 to transmit one or more signals 121 that can be related, for example, to information about the vicinity of monitor 100. Monitor 100 also comprises sensor 130, coupled to transmitter 120 over substrate 110 in the present embodiment to scan the vicinity of monitor 100. There can be embodiments, however, where one or more of the monitors of sensor system 10 may not have sensor 130 and, thus, serve mainly to relay information to and/or from other monitors or components of sensor system 10. As will be further described below, monitor 100 also comprises processing circuitry 140 and power source 150 coupled to substrate 110 in the present example.

At least a portion of monitor 100 can be substantially imperceptible to an unaided human when attached to a surface for deployment as part of sensor system 10 in the present embodiment. To that end, substrate 110 can comprise a flexible and/or plastic substrate that can be translucent and/or even substantially transparent to make monitor 100 less visible. In the same or other embodiments, substrate 110 can comprise a flexible plastic material such as polyethylene naphthalate (PEN), available from Teijin DuPont Films of Tokyo, Japan under the trade name planarized “Teonex® Q65,” a polyethylene terephthalate (PET) material, a polyethersulfone (PES) material, a polyimide, a polycarbonate, a cyclic olefin copolymer, and/or a liquid crystal polymer. Such plastic, non-metallic materials, even if accompanied by minimal metal interconnects and/or other structures, can also be beneficial, for example, to limit the detectability of monitor 100 by magnetometers. There can be embodiments where other portions of monitor 100 can also be configured to avoid detection. For example, one or more of sensor 130 and/or transmitter 120 can comprise components and/or transistors that are substantially translucent for decreased visibility. In one embodiment, sensor 130 and/or transmitter 120 can comprise at least one of an amorphous silicon material, a zinc oxide material, a zinc indium oxide material, a gallium zinc oxide material, and/or an organic semiconductor material such as pentacene. In some of these examples, monitor 100 can be substantially imperceptible to an unaided human eye at a distance of at least approximately 1 meter.

In the present embodiment, substrate 110 comprises a substrate suitable for a semiconductor manufacturing process, where components such as power source 150, processing circuitry 140, sensor 130, and/or transmitter 120 can be fabricated or formed over substrate 110. There can also be embodiments where one or more components of monitor 100 can be mounted over, rather than formed over, substrate 110. As an example, power source 150, processing circuitry 140, sensor 130, and/or transmitter 120, can comprise one or more unpackaged bare die mounted over substrate 110. In the same or other examples, such similar unpackaged bare die can be thinned before mounting over substrate 110. There can be embodiments where a bare die mounted over substrate 110 can comprise commercial off the shelf (COTS) circuits, and/or application specific integrated circuits (ASICs). Some of the embodiments described above can comprise components, such as transmitter 120 and/or sensor 130, configured to be flexible along with substrate 110 when substrate 110 is flexed, and/or configured to be translucent for decreased visibility.

In the present embodiment, monitor 100 comprises power source 150 configured to power one or more of the components of monitor 100, such as sensor 130 and/or transmitter 120. There can be embodiments where power source 150 comprises a battery, such as a lithium battery and/or a rechargeable battery. In the same or other examples, such battery can be thin enough to be flexible with substrate 110. In such embodiments, the battery could comprise a thickness of, for example, approximately 0.35 millimeters to approximately 0.40 millimeters. Power source 150 could comprise one or more capacitors to store charge in the same or other embodiments. There can be examples where power source 150 could comprise a solar cell, such as an organic solar cell, coupled to or formed over substrate 110. In such examples, power source 150 could comprise a combination of one or more batteries or capacitors with one or more solar cells, and/or the organic solar cells could be configured to charge and/or recharge the one or more batteries or capacitors. In some embodiments, power source 150 can comprise a piezoelectric material or device. In the same or other examples, the piezoelectric material or device of power source 150 can comprise a portion of sensor 130, such as when sensor 130 comprises an acoustic sensor or array. There can also be embodiments where power source 150 can comprise a thermoelectric material or device to generate power from a heat recovery process. In a different embodiment, power source 150 can be located off of substrate 110, and/or can be a remote power source providing power to the components over substrate 110.

Transmitter 120 can be configured to transmit one or more first signals 121 noncontinuously in some embodiments, for example, to conserve power and/or otherwise limit a discharge of power supply 150. As an example, transmitter 120 could be configured to transmit one or more first signals 121 periodically, or upon expiration of a predetermined period of time. In the same or other examples, apparatus 100 could comprise a receiver mechanism at substrate 110 configured to receive incoming signals, such as control signals from other components of sensor system 10. In such examples, transmitter 120 could transmit one or more signals 121 upon request when the control signals are received by the receiver mechanism over substrate 110. There can be examples where the receiver mechanism scans for incoming signals periodically, rather than continuously, for example, to conserve power. In some embodiments, the receiver mechanism can be part of and/or coupled to one or more of sensor 130, transmitter 120, and/or processing circuitry 140.

When deployed as part of sensor system 10, as seen in FIG. 3, monitor 100 can be coupled to a structure in order to locate sensor 130 (FIG. 1) proximate to a desired location to be monitored, and/or to locate transmitter 120 (FIG. 1) at a desired location for transmitting or forwarding information to other components of sensor system 10. In some applications, the structure can comprise a structure of an urban environment, such as one of structures 361, 362, or 363 (FIG. 3), a wall, a post, or a tree, among others. As an example, structure 361, 362, or 363 can be buildings in a city or a town.

In some examples, monitor 100 can be coupled directly to a surface of the structure described above. There can also be examples where the surface can comprise a surface of a placard that can in turn be coupled to the structure. For example, in FIG. 2, monitor 100 is coupled to surface 250 of placard 251, where placard 251 can be a poster coupled to a wall of structure 361, as seen in FIG. 3. Placard 251 is fashioned as a typical advertisement poster in the example of FIGS. 2-3 and, as a result, can permit the installation of both placard 251 and monitor 100 without raising suspicion. In some examples, monitor 100 can be coupled with placard 251 in such a way as to make monitor 100 inconspicuous to even the installer of placard 251. In other similar examples, such as in FIG. 1, monitor 100 can be coupled to surface 160 of a placard, where the placard can comprise an adhesive film, a translucent decal, and/or a front surface capable of displaying an arbitrary image. In the same or other examples, the placard may also be attachable to a structure such as structure 361 (FIG. 3), and/or may be similar to placard 251 (FIG. 2).

There can be embodiments where one of the placards described above is flexible, and monitor 100 is configured to flex along with the placard, as needed during, for example, rolling of the placard for storage and unrolling of the placard for installation. In the same or other embodiments, monitor 100 can be embedded within the placard, or layered between the placard and the structure, or coupled to the exterior surface of the placard. There can be some of such embodiments where at least a portion of front side 180 of monitor 100 is covered by the placard when the placard is coupled to the structure to thereby make monitor 100 more inconspicuous. In such examples, front side 180 can face away from the structure when deployed, and one or more portions of the placard located over sensor 130 and/or transmitter 120 at front side 180 of monitor 100 could be removed to expose sensor 130 and/or transmitter 120, so as to limit restrictions on their respective sensing, receiving, and/or transmitting capabilities. In other examples, the placard can comprise a non-infrared absorbing plastic or other material so that the one or more portions of the placard located over sensor 130 and/or transmitter 120 can remain over sensor 130 and/or transmitter 120.

In the example shown in FIGS. 1-3, sensor 130 is configured to scan for vicinity data 131 around a vicinity of monitor 100. To that end, sensor 130 can comprise one of several different types of sensors, such as an acoustic sensor, a motion sensor, a chemical sensor, a pressure sensor, an image sensor, and/or a temperature sensor. In the same or other embodiments, sensor 130 can comprise a micro electro mechanical system (MEMS) device located at substrate 110. In the example shown in FIG. 1, transmitter 120 and sensor 130 are coupled together via processing circuitry 140, where processing circuitry 140 is configured to communicate with sensor 130 to generate one or more vicinity parameters 141 based on vicinity data 131 scanned or received by sensor 130. In some examples, vicinity parameter 141 can comprise a traffic presence parameter, a traffic flow parameter, a traffic quantity parameter, a noise parameter, a wireless signal parameter, and/or a chemical presence parameter, among others. In some examples, the wireless signal parameter can comprise information about one or more characteristics of detected radiofrequency or microwave signals.

Once generated, vicinity parameter 141 can be sent to transmitter 120 for transmission as part of one or more signals 121. In some examples, such as when transmitter 120 is configured to transmit one or more signals 121 noncontinuously, vicinity parameter 141 can be stored in processing circuitry 140 until the next transmission is executed. In such examples, processing circuitry 140 could comprise one or more memory elements, such as a nonvolatile memory array of thin film transistors, to store information such as vicinity parameter 141.

In some implementations, signals 121 transmitted via transmitter 120 can be configured to be imperceptible to an unaided human, thereby limiting the detectability of monitor 100. There can be embodiments where transmitter 120 can comprise an infrared emitter configured to modulate and/or transmit the one or more signals 121 as invisible infrared signals. In the same or other embodiments, transmitter 120 can comprise an infrared reflector configured to transmit one or more signals 121 via reflective infrared modulation of infrared light incident on transmitter 120. There can be examples where the incident infrared light can comprise ambient infrared light, or infrared light coming from an infrared emitter aimed at the first transmitter. Transmitter 120 as described above can comprise a digital display in some embodiments, such as an electrophoretic display and/or a cholesteric liquid crystal display, to transmit the one or more signals 121 as modulated infrared signals. For example, pixels of an electrophoretic display could be turned on or off to modulate the reflection of incident infrared light or ultraviolet light and thereby generate one or more signals 121. There can also be embodiments where transmitter 120 can comprise one or more light emitting diodes (LEDs), such as one or more organic LEDs. Other non-infrared transmissions may be possible. For example, in a different embodiment, transmitter 120 could comprise a radio frequency (RF) transmitter and/or an antenna coupled to substrate 110 to transmit one or more signals 121 via RF transmissions. Other predetermined transmission frequencies can also be used. It should be noted that, although processing circuitry 140 is shown in FIG. 1 as distinct from sensor 130 and transmitter 120, there can be embodiments where portions of processing circuitry 140 can be part of sensor 130 and/or part of transmitter 120.

As illustrated in FIG. 3, monitor 100 can be deployed as part of sensor system 10 to transmit signals 121 to remote monitor 390, where remote monitor 390 is configured to receive and process signals 121 to generate a vicinity report based on the vicinity parameters 141 (FIG. 1) from monitor 100. In some examples, the vicinity report can comprise information regarding traffic or environmental conditions, such as number of vehicles or individuals present, at the vicinity of monitor 100. Although remote monitor 390 is shown in a vehicle-mounted configuration in FIG. 3, there can be other embodiments where remote monitor 390 can be located at a fixed structure.

FIG. 3 also illustrates that sensor system 10 can comprise other monitors similar to monitor 100, such as monitor 311 at structure 363, and monitor 321 at structure 362. In the present example, monitors 311 and 321 are coupled to placards 310 and 320, respectively, similar to the way monitor 100 is coupled to placard 251, as described above in FIG. 2. In one embodiment, monitors 311 and 321 are configured to transmit signals 3111 and 3211, respectively, where signals 3111 and 3211 can be similar to signal 121 but related to the respective vicinities of monitors 311 and 321.

The embodiment of FIG. 3 shows that remote monitor 390 need not receive signals 121 directly from monitor 100. Instead, signals 121 can be relayed, for example, from monitor 100 to monitor 311, from monitor 311 to monitor 321 via signals 3111, and then from monitor 321 to remote monitor 390 via signals 3211. As a result, remote monitor 390 can receive vicinity parameters 141 (FIG. 1) from the vicinity of monitor 100, even if remote monitor 390 is not in direct line-of-sight relationship with monitor 100. Such capability can be beneficial, for example, where signals 121 are infrared signals that would otherwise require a direct line-of-sight relationship for proper transmission and reception.

In some embodiments, one or more of the monitors of sensor system 10 could comprise respective receiver mechanisms. For example, monitor 311 can comprise a receiver mechanism configured to receive one or more incoming signals. In some embodiments, the receiver mechanism can comprise or be part of a sensor similar to sensor 130 (FIG. 1). In other embodiments, the receiver mechanism can be separate from the sensor of monitor 311, and/or can be part of transmitter 120 (FIG. 1). There can also be embodiments where monitor 311 may not comprise a sensor similar to sensor 130 (FIG. 1), while still comprising the receiver mechanism coupled at the substrate of monitor 311. In such embodiments, monitor 311 may not be able to generate vicinity data about a vicinity of monitor 311, but would be able to receive and relay vicinity data received from other monitors of sensor system 10. In one or more of the above embodiments, the transmitter of monitor 311 can be configured to relay at least a portion of the one or more incoming signals to other components of sensor system 10, such as to monitor 100, or to remote monitor 390. In the same or a different embodiment, the transmitter of monitor 311 can be configured to relay signals 121 as well as signals regarding the vicinity of monitor 311 to monitor 321.

In one example, the one or more incoming signals received by the receiver mechanism can comprise at least a portion of signals 121 from monitor 100. In the same or other examples, the one or more incoming signals can comprise control signals from, for example, remote monitor 390. There can be embodiments where such control signals could comprise information or commands for one or more of the monitors of sensor system 10 to, for example, communicate with each other and/or to adjust their respective sensors. As an example, the control signals received by monitor 311 via monitor 321 could be transmitted to monitor 100 to direct monitor 100 to adjust a sensitivity or a directionality of sensor 130 (FIG. 1).

There can be implementations where the monitors of sensor system 10 can be configured to monitor each other. In one embodiment, transmitter 120 (FIG. 1) of monitor 100 can be configured to transmit a monitoring signal, while the sensor of monitor 311 can be configured to receive the monitoring signal and to detect an interruption of the monitoring signal. If monitor 311 detects such interruption of the monitoring signal of monitor 100, the transmitter of monitor 311 can be configured to signal other components of sensor system 10, such as remote monitor 390 via monitor 321, about the interruption. There can be examples where a continuous or erratic interruption of the monitoring signal can be interpreted to establish that transmitter 120 (FIG. 1) of monitor 100 has been disabled. In the same or other examples, the monitoring signal can be interrupted each time an individual, a vehicle, or other traffic elements passes between monitors 100 and 311, such that the frequency of such interruptions can be used to establish one or more traffic parameters.

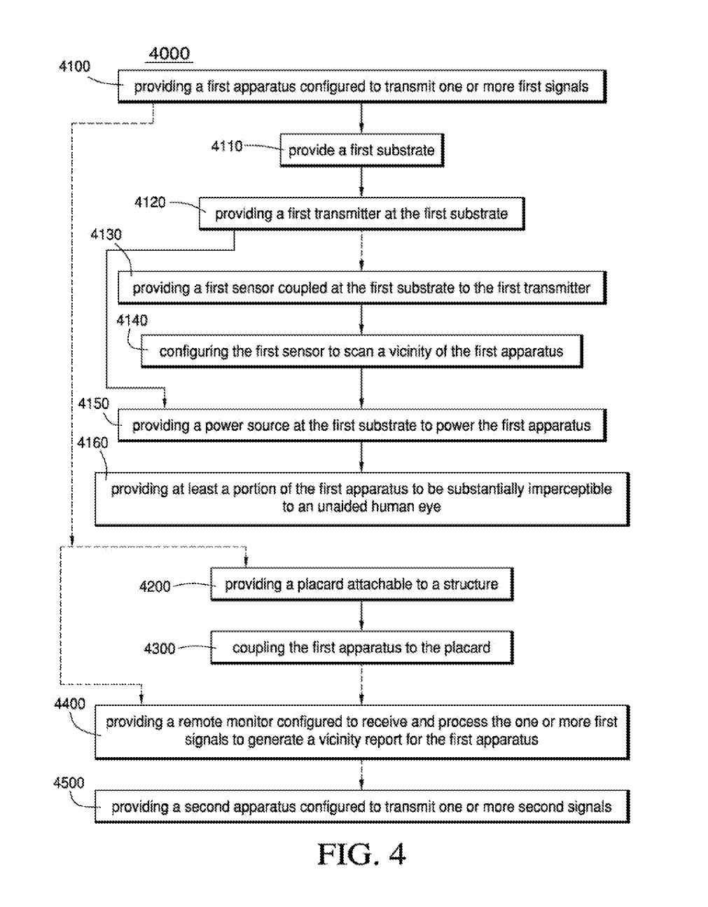

Continuing with the figures, FIG. 4 illustrates a flowchart of a method 4000 for providing a vicinity sensor system in accordance with the present disclosure. In some examples, the vicinity sensor system of FIG. 4 can be similar to sensor system 10 as described above in FIGS. 1-3.

Block 4100 of method 4000 comprises providing a first apparatus configured to transmit one or more first signals. In some examples, the first apparatus can be similar to monitor 100 (FIGS. 1-3), and the one or more first signals can be similar to signals 121 (FIGS. 1, 3). Block 4100 can comprise several sub-blocks, as described below.

Sub-block 4110 of block 4100 comprises providing a first substrate. There can be examples where the substrate of sub-block 4110 can be substantially translucent or transparent, and/or can comprise at least one of a flexible substrate and/or a plastic substrate. In some embodiments, the first substrate of block 4110 can be similar to substrate 110 (FIG. 1), as described above for monitor 100.

Sub-block 4120 of block 4100 comprises providing a first transmitter at the first substrate of block 4110. The first transmitter of sub-block 4120 can be similar to transmitter 120 (FIG. 1) of monitor 100 (FIGS. 1-3) in some examples, and can be used to transmit one or more first signals similar to signals 121 (FIGS. 1, 3). In some examples, providing the first transmitter as part of sub-block 4120 can comprise providing at least one of an infrared emitter, an electrophoretic display, a liquid crystal display, or an RF transmitter.

Sub-block 4130 of block 4100 comprises providing a first sensor coupled to the first transmitter of block 4120 at the first substrate of block 4110. There can be embodiments where the first sensor can comprise, for example, a MEMS device, an acoustic sensor, a motion sensor, a chemical sensor, a pressure sensor, an image sensor, and/or a temperature sensor. In some embodiments, the first sensor of sub-block 4130 can be similar to sensor 130 (FIG. 1), as described above for monitor 100 (FIGS. 1-3). Sub-block 4130 can be optional in some examples, such as when the first apparatus is not intended to gather information about its vicinity, but is rather configured to merely relay information from other apparatuses of the vicinity sensor system of method 4000.

In embodiments comprising sub-block 4130, block 4100 can also comprise sub-block 4140 for configuring the first sensor to scan a vicinity of the first apparatus of block 4100. In some examples, sub-block 4140 can be executed to generate, based on the scan, a vicinity parameter for transmission via the first transmitter of sub-block 4120 as part of the one or more first signals described for sub-block 4120. In such examples, the vicinity parameter can comprise at least one of a traffic presence parameter, a traffic flow parameter, a traffic quantity parameter, a noise parameter, or a chemical presence parameter. Some implementations of sub-block 4140 can be carried out pursuant to the description above of monitor 100 (FIGS. 1-3).

Block 4100 continues with sub-block 4150 for providing a power source at the first substrate to power the first apparatus of block 4100. There can be examples where the power source can comprise an organic solar cell, one or more capacitors, and/or one or more flexible batteries. In some examples, the power source of block 4150 can be similar to power source 150 (FIG. 1) as described above with respect to monitor 100 (FIGS. 1-3).

Block 4100 also comprises sub-block 4160 in the present example for providing at least a portion of the first apparatus to be substantially imperceptible to an unaided human. In some examples, at least one of the substrate, the first transmitter, the first sensor, and/or the power source of the first apparatus of block 4100 can be translucent to diminish the visibility of the first apparatus. In the same or other examples, the first apparatus can be imperceptible when attached to a surface as described above with respect to monitor 100 coupled to surface 150 (FIG. 2) or to surface 250 (FIG. 2). In the same or other examples, the first apparatus can be substantially imperceptible to an unaided human beyond a certain distance, such as beyond a distance of at least approximately 1 meter.

In some embodiments, method 4000 can optionally comprise block 4200 for providing a placard attachable to a structure. There can be examples where the placard can be similar to placard 251 (FIG. 2). In embodiments comprising block 4200, method 4000 can also comprise block 4300 for coupling the first apparatus to the placard. There can be embodiments where the placard and the first apparatus can be flexible, such that the first apparatus can be configured to flex with the placard. In some embodiments, block 4300 can be executed consistent with the description above of monitor 100 being coupled to surface 250 of placard 251. For example, the placard of blocks 4200 and 4300 can cover at least a portion of the first apparatus when coupled together for attachment to a surface.

Continuing with method 4000, block 4400 can comprise providing a remote monitor configured to receive and process, as needed, the one or more first signals to thereby generate a vicinity report for the first apparatus. In some embodiments, the remote monitor can be similar to remote monitor 390 (FIG. 3) as described above with respect to sensor system 10 (FIGS. 1-3). For example, the remote monitor of block 4400 can be configured to communicate with the first transmitter of sub-block 4120 to receive infrared transmissions comprising the one or more first signals.

Block 4500 of method 4000 comprises providing a second apparatus configured to transmit one or more second signals. In some examples, the second apparatus can be similar to the first apparatus of block 4100 and/or to one of monitors 311 or 321 (FIG. 3), as described above with respect to sensor system 10 (FIGS. 1-3). Block 4500 can be optional in some examples, and may be executed in situations where the remote monitor of block 4400 is not in a line-of-sight relationship with the first apparatus of block 4100 to directly receive the one or more first signals from the transmitter of block 4120. In such situations, the second apparatus may receive the one or more first signals from the first apparatus and may then forward them as part of the one or more second signals to the remote monitor of block 4400.

In some examples, one or more of the different blocks of method 4000 can be combined into a single block or performed simultaneously, and/or the sequence of such blocks can be changed. For example, the first apparatus in block 4100 can be provided simultaneously with the placard of block 4200. In such an example, blocks 4100 and 4200 could be combined, and/or block 4300 could be eliminated.

In the same or other examples, some of the steps of method 4000 can be subdivided into several sub-steps. For example, block 4400 could be subdivided such that the processing and/or generating of the vicinity report could comprise one or more other blocks or sub-blocks.

There can also be examples where method 4000 can comprise further or different procedures. As an example, method 4000 could comprise other blocks for scanning a vicinity of the second apparatus of block 4500 and/or for receiving the one or more second signals to generate a vicinity report for the second apparatus. In addition, as described above, some of the blocks of method 4000 can also be optional in some implementations. Other variations can be implemented for method 4000 without departing from the scope of the present disclosure.

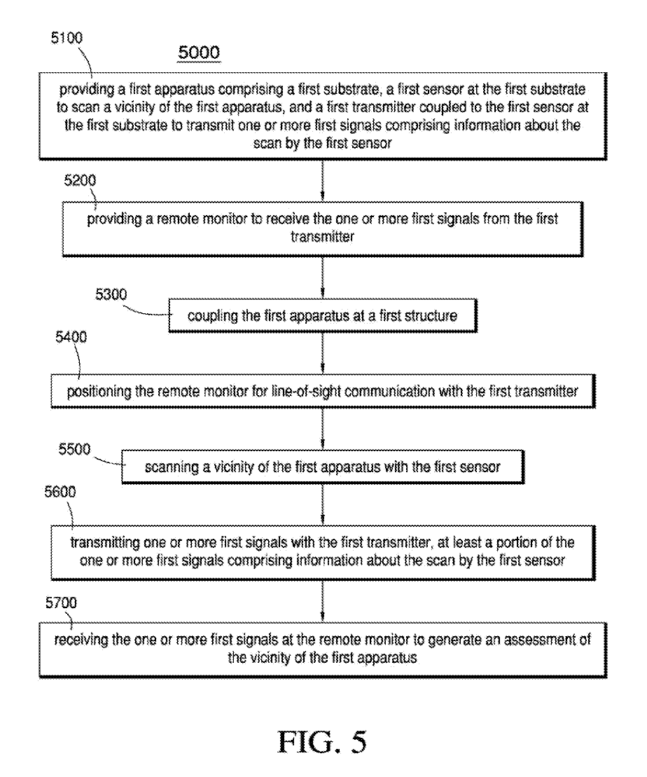

Continuing with the figures, FIG. 5 illustrates a flowchart for a method 5000 of operating a vicinity sensor system in accordance with the present disclosure. In some examples, the sensor system of FIG. 5 can be similar to sensor system 10 as described above in FIGS. 1-3 or to the sensor system described above for method 4 in FIG. 4.

Method 5000 comprises block 5100 for providing a first apparatus comprising a first substrate, a first sensor at the first substrate to scan a vicinity of the first apparatus, and a first transmitter coupled to the first sensor at the first substrate to transmit one or more first signals comprising information about the scan by the first sensor. There can be examples where the first apparatus of method 5000 can be similar to monitor 100 (FIGS. 1-3), and/or to the first apparatus of method 4000 (FIG. 4). For example, the one or more first signals can be invisible to an unaided human eye when transmitted to limit the detectability of the first apparatus.

Method 5000 also comprises block 5200 for providing a remote monitor to receive the one or more first signals from the first transmitter. In some embodiments, the remote monitor of block 5200 can be similar to remote monitor 390 (FIG. 3) as described above for sensor system 10 (FIGS. 1-3).

Block 5300 of method 5000 comprises coupling the first apparatus of block 5100 to a first structure. In some examples, the first apparatus can be coupled to a structure in an urban environment, as described above for monitor 100 being coupled to structure 361 in FIG. 1. In some examples, the first apparatus can be coupled directly to the first structure. In other examples, the first apparatus can be coupled to a placard, where the placard can be coupled to the structure, as described above with respect to monitor 100 being coupled to surface 250 of placard 251 (FIGS. 2-3), or to surface 150 (FIG. 1) of the placard comprising an adhesive film or a decal. In some examples, coupling the first apparatus to the structure via a placard can aid in making the first apparatus less detectable to an unaided human.

Block 5400 of method 5000 comprises positioning the remote monitor of block 5200 for line-of-sight communication with the first transmitter of the first apparatus of block 5100. Line-of-sight communication can be needed, for example, when the one or more first signals are transmitted as infrared signals.

In some examples, block 5400 can be executed by positioning a detection mechanism of the remote monitor in a direct line-of-sight relationship with the first transmitter of the first apparatus. In other examples, such direct relationship may be impossible or inconvenient to achieve. In such examples, method 5000 can comprise providing a second apparatus similar to the first apparatus of block 5100, where a receiver of the second apparatus is positioned in a direct line-of-sight relationship with the first transmitter of the first apparatus, and where the detection mechanism of the remote sensor is positioned in a direct line-of-sight relationship with a second transmitter of the second apparatus. The second apparatus could be configured to relay the one or more signals from the first apparatus to the remote monitor in such embodiments.

Block 5500 of method 5000 comprises scanning a vicinity of the first apparatus with the first sensor. In some examples, block 5500 can be carried out pursuant to the description above of how sensor 130 (FIG. 1) scans the vicinity of monitor 100 in sensor system 10 (FIGS. 1-3) to gather vicinity data 131.

Method 5000 also comprises block 5600 for transmitting one or more first signals with the first transmitter, at least a portion of the one or more first signals comprising information about the scan in block 5500 by the first sensor. There can be examples where block 5600 can be carried out pursuant to the description above of how transmitter 120 (FIG. 1) of monitor 100 transmits signals 121 (FIGS. 1 and 3) comprising vicinity parameter 141 (FIG. 1) as derived from vicinity data 131 (FIG. 1).

Block 5700 of method 5000 comprises receiving the one or more first signals at the remote monitor to generate an assessment of the vicinity of the first apparatus. In some examples, the one or more first signals can be received directly from the first apparatus in situations where the first apparatus and the remote monitor are in a direct line of sight relationship relative to each other. In other examples, the one or more first signals can be received as forwarded by the second transmitter of the second apparatus described above with respect to block 5400. Once received, the one or more first signals can be processed by the remote monitor to generate the assessment of the vicinity of the first apparatus. In some examples, the assessment can comprise a vicinity report, as described above with respect to the processing of signals 121 by remote monitor 390 (FIG. 3).

In some examples, one or more of the different blocks of method 5000 can be combined into a single block or performed simultaneously, and/or the sequence of such blocks can be changed. For example, the remote monitor in block 5200 could be provided before the first apparatus in block 5100. In the same or other examples, some of the steps of method 5000 can be subdivided into several sub-steps. For example, block 5400 could be subdivided into several sub-blocks where a second apparatus is used as described above to forward the one or more first signals of the first apparatus to the remote monitor. There can also be examples where method 5000 can comprise further or different procedures. As an example, method 5000 could comprise another block for transmitting a command from the remote monitor to the first apparatus. Other variations can be implemented for method 5000 without departing from the scope of the present disclosure.

Although the vicinity sensor systems and related methods have been described herein with reference to specific embodiments, various changes may be made without departing from the spirit or scope of the present disclosure. For example, in some embodiments, sensor system 10 (FIGS. 1-3) could comprise further monitors similar to monitor 100 and/or configured to communicate amongst each other to scan and forward information about their respective vicinities to remote monitor 390 (FIG. 3). Also, the sensors of sensor system 10 could periodically and/or non-continuously sense or monitor their environment and/or listen for a request to transmit the stored vicinity parameter. Additional examples of such changes have been given in the foregoing description. Accordingly, the disclosure of embodiments herein is intended to be illustrative of the scope of the invention and is not intended to be limiting. It is intended that the scope of this application shall be limited only to the extent required by the appended claims. The vicinity sensor systems and related methods discussed herein may be implemented in a variety of embodiments, and the foregoing discussion of certain of these embodiments does not necessarily represent a complete description of all possible embodiments. Rather, the detailed description of the drawings, and the drawings themselves, disclose at least one preferred embodiment, and may disclose alternative embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
a first apparatus comprising:
a first substrate; and
a first transmitter supported by the first substrate;
wherein:
the first substrate comprises at least one of:
a flexible substrate; or
a plastic substrate;
the first transmitter is configured to transmit one or more first signals;
the one or more first signals are imperceptible to an unaided human; and
when coupled to a first surface, at least a portion of the first apparatus is configured to be substantially imperceptible to an unaided human eye.

2. The system of claim 1, wherein at least one of:
the portion of the first apparatus is configured to be substantially imperceptible to the unaided human eye at a distance of at least approximately 1 meter;
at least one of the first substrate or the first transmitter is translucent; or
the first transmitter comprises either one of (a) an infrared emitter to transmit the one or more first signals as infrared signals or (b) an RF transmitter at the first substrate to transmit the one or more first signals.

3. The system of claim 1, wherein:
the first transmitter comprises a digital display; and
the one or more signals are transmitted via the digital display.

4. The system of claim 1, wherein:
the first transmitter is configured to transmit the one or more signals noncontinuously; and
the first transmitter is configured to transmit the one or more signals upon at least one of:
a receipt of a control signal; or
an expiration of a predetermined period.

5. The system of claim 1, wherein:
the first apparatus further comprises a power source at the first substrate to power the first apparatus; and
the power source comprises at least one of:
an organic solar cell, a flexible battery, one or more capacitors, a piezoelectric material, or a thermoelectric material.

6. The system of claim 1, wherein:
the first apparatus further comprises:
a first sensor coupled to the first transmitter and supported by the first substrate to scan a vicinity of the first apparatus for vicinity data; and
processing circuitry at the substrate to generate a vicinity parameter based on the vicinity data;
and
the first transmitter is configured to transmit the vicinity parameter as part of the one or more signals.

7. The system of claim 6, wherein at least one of:
the first apparatus further comprises a memory device supported by the first substrate and configured to store the vicinity parameter;
the first sensor comprises at least one of an acoustic sensor, a motion sensor, a chemical sensor, a pressure sensor, an image sensor, or a temperature sensor;
the first sensor comprises a MEMS device; or
the vicinity parameter comprise at least one of a traffic presence parameter, a traffic flow parameter, a traffic quantity parameter, a noise parameter, a wireless signal parameter, or a chemical presence parameter.

8. The system of claim 1, further comprising at least one of:
a placard attachable to a structure, the first surface comprising a placard surface of the placard and the first apparatus being coupled to the placard surface;
the first apparatus further comprises a first receiver mechanism configured to receive one or more incoming signals, the one or more incoming signals comprising at least one of (a) one or more control signals or (b) one or more monitoring signals; or
a remote monitor configured to receive and process the one or more signals from the first transmitter of the first apparatus.

9. The system of claim 8, wherein at least one of:
the placard is flexible, and the first apparatus is configured to flex with the placard; or
at least a portion of a side of the first apparatus facing away from the structure is covered by the placard when the placard is attached to the structure.

10. The system of claim 8, further comprising:
a second apparatus comprising:
a second substrate;
a second transmitter supported by the second substrate; and
at least one of:
a receiver mechanism coupled to the second transmitter; or
a second sensor coupled to the second transmitter.

11. The system of claim 10, wherein at least one of:
the second transmitter is configured to transmit one or more second signals to the remote monitor, based on a scan by the second sensor, when attached to a second surface; or
at least one of the remote monitor or the second apparatus is configured to receive the one or more first signals from the first apparatus via a line-of-sight transmission.

12. The system of claim 10, wherein:
the receiver mechanism of the second apparatus is configured to receive one or more incoming signals comprising at least one of:
one or more control signals; or
at least a portion of the one or more first signals from the first apparatus; and
the second transmitter is configured to relay at least a portion of the one or more incoming signals to at least one of the first apparatus or the remote monitor.

13. The system of claim 10, wherein:
the first transmitter of the first apparatus is configured to transmit a monitoring signal;
the second sensor of the second apparatus is configured to:
receive the monitoring signal; and
detect an interruption of the monitoring signal;
and
the second transmitter is configured to signal the interruption of the monitoring signal to the remote monitor to establish at least one of:
a traffic parameter; or
a disablement of the first transmitter.

14. A method comprising:
providing a first apparatus comprising:
a first substrate comprising at least one of a flexible substrate or a plastic substrate;
a first sensor at the first substrate to scan a vicinity of the first apparatus; and
a first transmitter at the first substrate and coupled to the first sensor, the first transmitter configured to transmit one or more first signals comprising information about the scan by the first sensor;
providing a remote monitor to receive the one or more first signals from the first transmitter;
scanning a vicinity of the first apparatus with the first sensor;
transmitting one or more first signals with the first transmitter, at least a portion of the one or more first signals comprising information about the scan by the first sensor; and
receiving the one or more first signals at the remote monitor to generate an assessment of the vicinity of the first apparatus;
wherein:
providing the first apparatus comprises:
configuring the first apparatus to be substantially imperceptible to an unaided human eye when the first apparatus is coupled at a first structure.

15. The method of claim 14, further comprising:
providing the remote monitor in a line-of-sight relationship with the first transmitter.

16. The method of claim 14, further comprising:
providing a second apparatus comprising:
a second substrate;
a receiver mechanism to receive the one or more first signals; and
a second transmitter coupled to the receiver mechanism at the second substrate to forward the one or more first signals;
providing the second receiver mechanism in a line-of-sight relationship with the first transmitter;
providing the remote monitor in a line-of-sight relationship with the second transmitter;
receiving the one or more first signals from the first apparatus at the receiver mechanism of the second apparatus; and
forwarding the one or more first signals from the second transmitter to the remote monitor.

17. The method of claim 14, wherein at least one of:
providing the first apparatus comprises at least one of:
providing the first transmitter to comprise at least one of an organic light emitting diode, an electrophoretic display, or a cholesteric liquid crystal display; and
configuring the first transmitter to transmit the one or more first signals via a reflective infrared modulation;
Or
providing the first transmitter to comprise an infrared reflector to transmit the one or more first signals as outbound infrared light reflected off the infrared reflector from incident infrared light, the incident infrared light comprising at least one of: (a) ambient infrared light; or (b) infrared light from an infrared emitter aimed at the first transmitter.

18. A method comprising:
providing a first apparatus configured to transmit one or more first signals;
wherein:
providing the first apparatus comprises:
providing a first substrate being substantially translucent and comprising at least one of:
a flexible substrate; or
a plastic substrate;
providing a first transmitter at the first substrate to transmit the one or more first signals; and
providing at least a portion of the first apparatus to be substantially imperceptible to an unaided human eye when attached to a surface.

19. The method of claim 18, wherein at least one of:
providing the first transmitter comprises providing at least one of an infrared emitter, an electrophoretic display, a liquid crystal display, or an RF transmitter; or
providing the first apparatus further comprises providing a power source at the first substrate to power the first apparatus, the power source comprising at least one of an organic solar cell, one or more capacitors, a piezoelectric material, a thermoelectric material, or a flexible battery.

20. The method of claim 18, further comprising at least one of:
providing a placard attachable to a structure and comprising the surface and coupling the first apparatus to the surface of the placard, wherein the placard is flexible and the first apparatus is configured to flex with the placard; or
providing a remote monitor configured to receive and process the one or more first signals to generate a vicinity report for the first apparatus.

21. The method of claim 18, wherein:
providing the first apparatus further comprises:
providing a first sensor coupled at the first substrate to the first transmitter, the first sensor comprising at least one of:
a MEMS device, an acoustic sensor, a motion sensor, a chemical sensor,
a pressure sensor, an image sensor, or a temperature sensor;
configuring the first sensor to:
scan a vicinity of the first apparatus; and
generate a vicinity parameter based on the scan, the vicinity parameter comprising at least one of:
a traffic presence parameter, a traffic flow parameter,
a traffic quantity parameter, or a chemical presence parameter;
and
configuring the first transmitter to generate the one or more first signals to comprise the vicinity parameter.

22. The method of claim 18, further comprising:
providing a second apparatus attachable to a second surface and configured to transmit one or more second signals;
wherein:
providing the second apparatus comprises:
providing a second substrate;
providing a second transmitter at the second substrate to transmit the one or more second signals;
providing a second sensor coupled to the second transmitter at the second substrate;
providing a receiver mechanism coupled to the second transmitter at the second substrate and configured to receive one or more incoming signals comprising at least one of:
one or more control signals; or
at least a portion of the one or more first signals from the first apparatus; and
configuring the second transmitter to forward at least a portion of the one or more incoming signals as part of the one or more second signals.
